(19) United States
(12) Patent Application Publication
(10) Pub. No.: US 2009/0277522 A1
(43) Pub. Date: Nov. 12, 2009

(54) DIVERTER ASSEMBLY FOR USE IN HOLDING SHOWER HEAD AND SHOWER NOZZLE

(75) Inventor: Nan-Hai HUANG, Guangdong Province (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP., Taichung County (TW)

(21) Appl. No.: 12/118,301

(22) Filed: May 9, 2008

(51) Int. Cl. F16K 11/02

(52) U.S. Cl. 137/876

(57) ABSTRACT

A diverter assembly includes a main body, a valve device and a movable body. The main body is hollow and has a water inlet tube and two water outlet tubes. One of the two water outlet tubes is communicated through a hose to a shower nozzle. The valve device is disposed at the main body and has a valve capable of linearly moving back and forth for steplessly adjusting the fluid communication among the water inlet tube and the water outlet tubes. The movable body is inserted in one end of the main body. A socket is pivotally disposed in the movable body, and has a hole for the shower nozzle to be inserted in. Accordingly, the diverter assembly can steplessly adjust the valve position for controlling the water to flow from any of the water outlet tubes into either or both of the shower nozzle or the shower head.

### BACKGROUND OF THE INVENTION

1. Field of Invention

The present invention relates to a diverter assembly for shower, and more particularly to a diverter assembly for holding a shower nozzle, and for controlling the amount of water to flow out through either or both of a shower head and a shower nozzle steplessly.

2. Related Art

Typical American shower appliances include a shower head fixed on a wall and a shower nozzle for a user to hold, and a diverter is disposed between the shower head and the shower nozzle for controlling the water to flow out through either or both of the shower head and the nozzle.

U.S. Pat. No. 7,299,510 discloses a holder device for a shower head and a shower nozzle as described above. The holder device includes an inlet and two outlet ports. A knob is pivotally disposed at one end of the holder device to operate a valve stem disposed inside the holder device for controlling the water flowing directions. An attaching device is disposed at the other end of the diverter assembly for holding the shower nozzle.

The two outlet ports of the holder device pass through a chamber, and the valve stem switches a valve member to positions corresponding to either one of the two outlet ports or between the two outlet ports. That is to say, when the valve stem switches the valve member to the position corresponding to one of the outlet ports, the water flows out through the other outlet port. When the valve stem switches the valve member to the position between the two outlet ports, the water flows out through both of the outlet ports.

Although the above-mentioned controlling technique of the three valve stem positions satisfies basic needs of users, when the valve stem switches to the position to have the water flow out through both of the outlet ports, that is, when the water flows out through both of the shower head and the shower nozzle, users can not further adjust the amount of the water flowing out through both of the shower head and the shower nozzle. The above situation is obviously to be improved for users.

On the other hand, an attaching device for the shower nozzle to be attached thereto includes a follower rotatably disposed on a partition secured to the holder device for the attaching device to be rotated along with the follower and for the opening of the attaching device to change the angle so that users can handle the shower nozzle or attach it in the holder device.

However, there is nothing between the attaching device and the partition for securing the attaching device, and the securing of the attaching device comes from the friction among the follower, the attaching device and the partition. If the screw for securing the follower and the attaching device is loosen, or after being used for a long time, a wearing issue occurs among the follower, the attaching device and the partition such that the attaching device loses securing capability, resulting in the falling of the shower nozzle secured in the attaching device. The falling of the shower nozzle can result in damaging of the shower nozzle or other appliance, or more seriously, hurt users thereof. Therefore, the attaching device is needed to be improved further.

### SUMMARY OF THE INVENTION

The primary object of the present invention is to solve the above-mentioned issues and to provide a diverter assembly for holding a handheld shower nozzle, and for controlling the amount of water to flow out through either or both of a shower head and the shower nozzle steplessly.

The secondary object of the present invention is to provide a diverter assembly for limiting the rotating angle of the shower nozzle so that the shower nozzle can be secured.

For achieving the above-mentioned objects, the diverter assembly according to the present invention includes a main body, a valve device and a movable body. The main body is hollow and has a water inlet tube and two water outlet tubes. One of the two water outlet tubes is communicated through a hose to a shower nozzle. The valve device is disposed at the main body and has a valve capable of linearly moving back and forth for steplessly communicating the water inlet tube with either or both of the water outlet tubes. The movable body is inserted in one end of the main body. A socket is pivotally disposed in the movable body, and has a hole for the shower nozzle to be inserted in.

Accordingly, the diverter assembly can steplessly adjust the valve position for controlling the water to flow from any of the water outlet tubes into either or both of the shower nozzle or the shower head, so as to achieve the object of steplessly adjusting the amount of water to flow out from the shower nozzle and the shower head.

Furthermore, the movable body has an upper blocking part and a lower blocking part opposing the socket. When the shower nozzle is inserted in the socket, the upper and the lower blocking parts are respectively for the shower nozzle to lean against, such that the rotating angle of the shower nozzle is limited to secure the shower nozzle.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of a shower appliance according to the present invention;

FIG. 2 is a perspective view of the present invention;

FIG. 3 is a cross-sectional structural schematic view of the movable body in the present invention;

FIG. 4 is a cross-sectional structural schematic view of the present invention;

FIG. 5 is a schematic view showing a first operating condition of the present invention;

FIG. 6 is a schematic view showing a second operating condition of the present invention; and

FIG. 7 is a schematic view showing a third operating condition of the present invention.

### DETAILED DESCRIPTION OF THE INVENTION

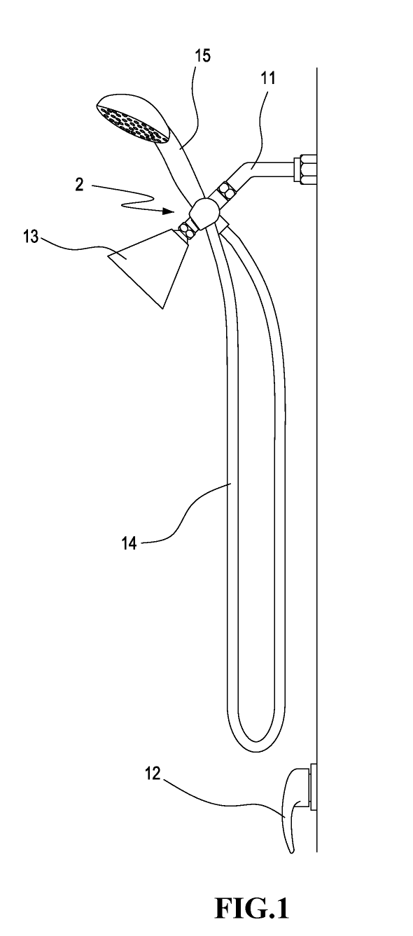

Refer to FIG. 1 to FIG. 7, which shows a preferred embodiment according to the present invention.

Refer to FIG. 1, which is a schematic view of a shower appliance according to the present invention. A shower appliance usually has a water outlet tube 11 protruding on top of a wall. The water flowing out of the water outlet tube 11 is controlled by a switch 12 disposed on bottom of the wall. The diverter assembly 2 of the present invention is integrated with the water outlet tube 11, respectively communicated with a shower head 13 and communicated with a handheld shower nozzle 15 by a hose 14.

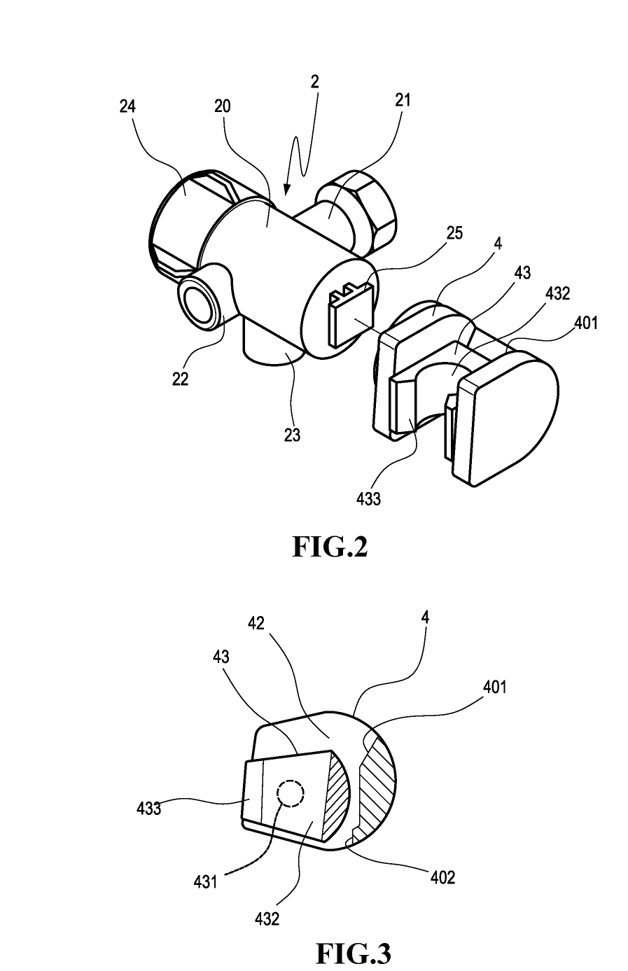

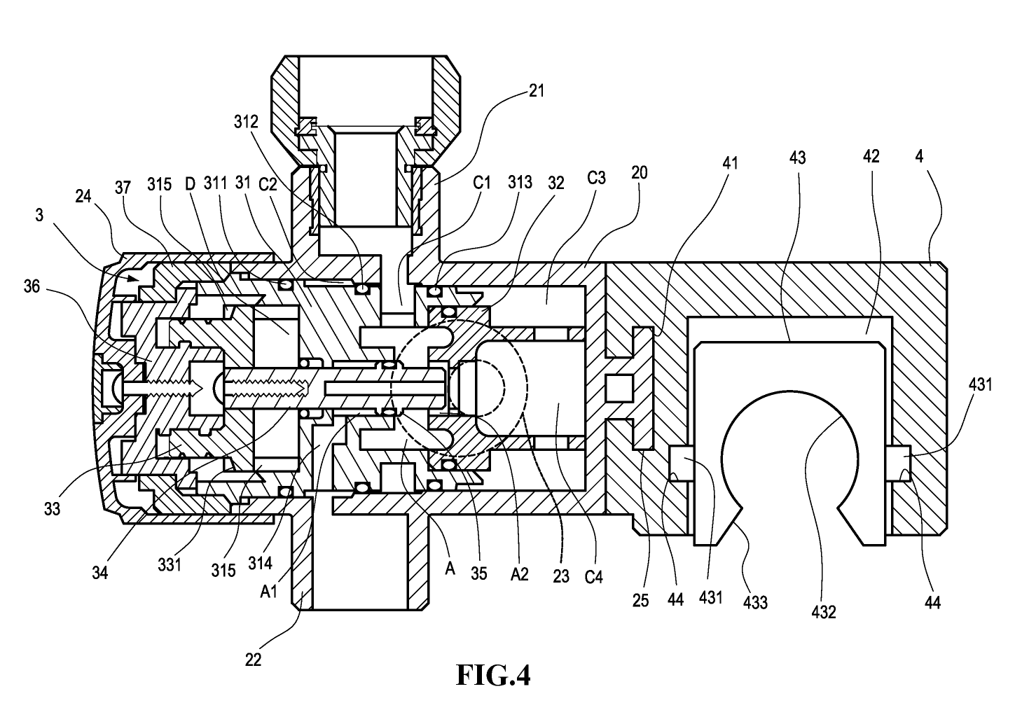

Refer to FIG. 2, which is a perspective view of the present invention. The diverter assembly 2 of the present invention has a hollow main body 20. The main body 20 has a water inlet tube 21, a first water outlet tube 22 and a second water outlet tube 23. A knob 24 is pivotally disposed at one end of the main body 20. The knob 24 rotates in accordance with a valve device 3 (referring to FIG. 4) disposed in the main body 20, and the valve device 3 controls the water to flow out from the first water outlet tube 22 and the second water outlet tube 23.

A sliding track 25 is disposed at one end of the main body 20 opposing the knob 24. The sliding track 25 is for a movable body 4 to engage in. A sliding groove 41 (referring to FIG. 4) is disposed on the movable body 4 corresponding to the sliding track 25 for the movable body 4 to match with the sliding track 25 by the sliding groove 41, so that the movable body 4 engages in the main body 20.

Refer to FIG. 2 to FIG. 4. FIG. 3 is a cross-sectional structural schematic view of the movable body in the present invention. FIG. 4 is a cross-sectional structural structural schematic view of the present invention. The movable body 4 is U-shaped and has an accommodating space 42 in the middle thereof. A socket 43 is pivotally disposed in the accommodating space 42. An upper blocking part 401 and a lower blocking part 402 are respectively disposed at upper and lower edges of the accommodating space 42 of the movable body 4. A protruding axis 431 is disposed respectively at two ends of the socket 43. An axial hole 44 is disposed on the movable body 4 corresponding to the protruding axis 431. The protruding axis 431 is tightly engaged to the axial hole 44. A hole 432 is disposed in the center of the socket 43 and has an opening 433 for the shower nozzle 15 to be inserted. The upper blocking part 401 and the lower blocking part 402 are respectively for the shower nozzle 15 to lean against, such that the rotating angle of the shower nozzle 15 is limited.

Refer to FIG. 4. The valve device 3 in the hollow main body 20 has a first sleeve 31 and a second sleeve 32 sleeved by each other. A partition A is formed between the first sleeve 31 and the second sleeve 32, and communicates a first passage A1 and a second passage A2. Three O-rings 311, 312 and 313 are disposed separately at an outer edge of the first sleeve 31 to form a first partition C1, a second partition C2 and a third partition C3 among the main body 20, the first sleeve 31 and the second sleeve 32. The first partition C1 communicates with the water inlet tube 21. The second partition C2 communicates with the first water outlet tube 22. The third partition C3 communicates with the second water outlet tube 23.

Further, the first sleeve 31 has a first through hole 314 communicating the first passage A1 and the second partition C2 for the first passage A1 to communicate with the first water outlet tube 22. The second sleeve 32 has a fourth partition C4 communicating with the second passage A2 and the third partition C3 respectively, so that the second passage A2 communicates with the second water outlet tube 23.

A spiral sleeve 33 is slidably disposed at one end of the first sleeve 31 opposing the second sleeve 32 and integrated with an axis 34. The axis 34 extends and passes the partition A and has a valve 35 at one section of the partition A. One end of the spiral sleeve 33 opposing the axis 34 is spirally engaged with a spiral rod 36. The spiral rod 36 is pivotally disposed to the main body 20 by a cover 37, and the section thereof extending out of the cover 37 is integrated with the knob 24 for the knob 24 to rotate the spiral rod 36 and further to slide the spiral sleeve 33 and the axis 34.

Further, an accommodating space D is disposed at one end of the first sleeve 31 opposing the second sleeve 32. A sliding groove 315 is disposed respectively at two opposite ends in the radical direction of the accommodating space D. A slider 331 is disposed respectively at the spiral sleeve 33 opposing the two sliding grooves 315. The spiral sleeve 33 can slide relative to the first sleeve 31 by the cooperating of the two sliding grooves 315 and two sliders 331.

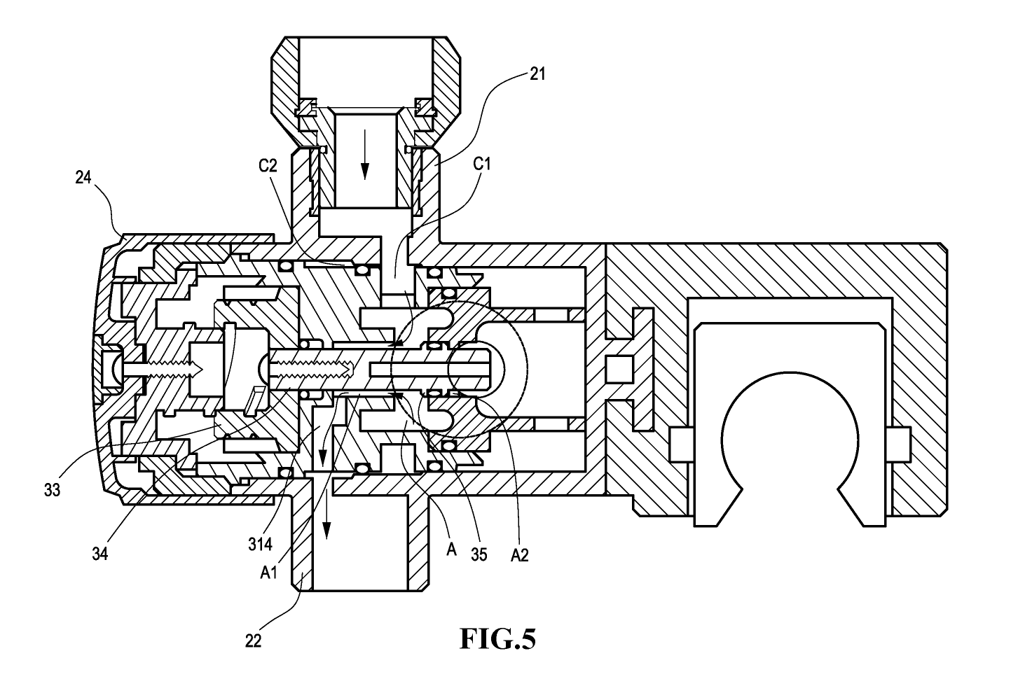

Refer to FIG. 5, which is a schematic view showing a first operating condition of the present invention. When a user rotates the knob 24 to slide the spiral sleeve 33 and the axis 34 toward the second passage A2 until the valve 35 closes the second passage A2, the water flows into the water inlet tube 21 and then enters the partition A through the first partition C1, and then flows through the first through hole 314 and the second partition C2 from the first passage A1, and is finally sprayed from the shower head 13 through the first water outlet tube 22.

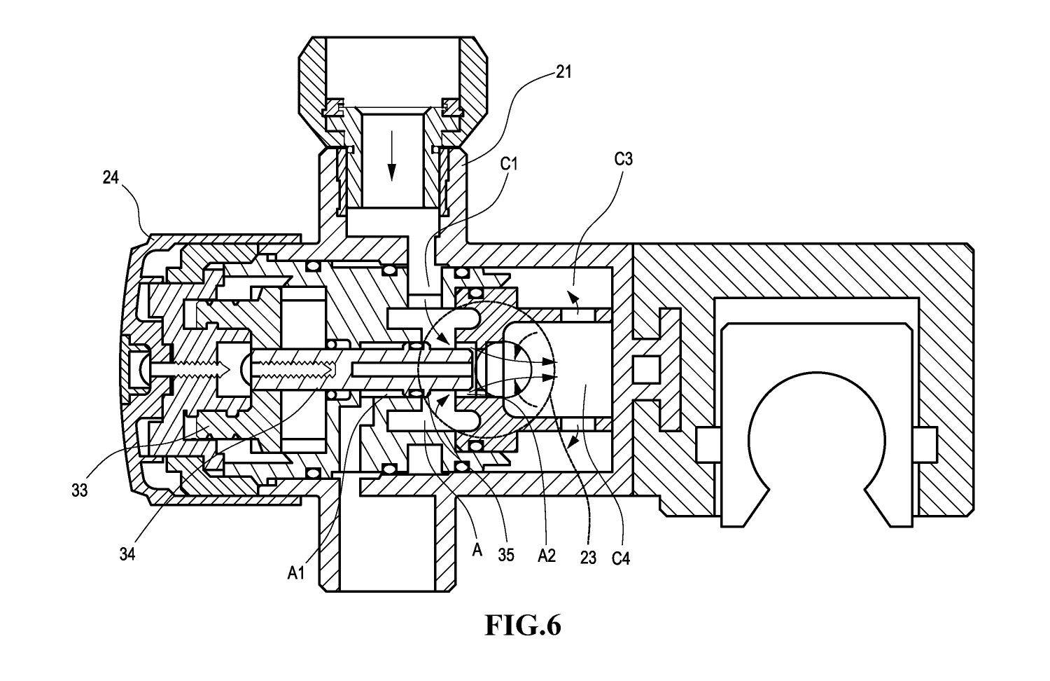

Refer to FIG. 6, which is a schematic view showing a second operating condition of the present invention. When a user wants the water to flow out of the shower nozzle 15 and rotates the knob 24 to slide the spiral sleeve 33 and the axis 34 toward the first passage A1 until the valve 35 closes the first passage A1, the water flows into the water inlet tube 21 and then enters the partition A through the first partition C1, and onto the third partition C3 through the second passage A2 and the fourth partition C4, and finally into the hose 14 through the second water outlet tube 23 to be sprayed from the shower nozzle 15.

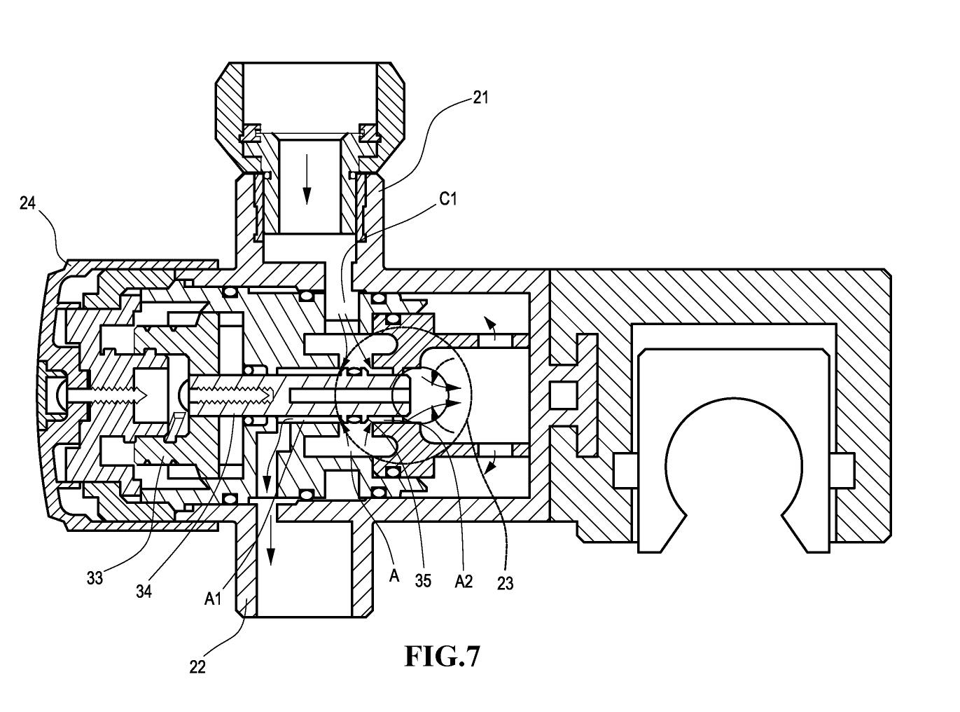

Refer to FIG. 7, which is a schematic view showing a third operating condition of the present invention. When a user wants the water to flow out of the shower head 13 and the shower nozzle 15 simultaneously and rotates the knob 24 to slide the spiral sleeve 33 and the axis 34 until the valve 35 is located between the first passage A1 and the second passage A2 and the first passage A1 communicates with the second passage A2, the water flows in through the water inlet tube 21 and then enters the partition A through the first partition C1, and onto the partition A through the first passage A1 and the second passage A2, and is finally sprayed from the shower head 13 and the shower nozzle 15 through the first water outlet tube 22 and second water outlet tube 23, so that the water is sprayed from the shower head 13 and the shower nozzle 15 simultaneously.

If the user wants the amount of water flowing out from the shower nozzle 15 more than from the shower head 13, the user can rotate the knob 24 to slightly slide the spiral sleeve 33 and the axis 34 toward the first passage A1 so that the valve 35 is near the first passage A1 and reduces the amount of water flowing from the first passage A1 to the shower head 13 and increases the amount of water flowing out from the shower nozzle 15. Thereby, the location of the valve 35 is finely adjusted by the knob 24 to steplessly adjust the amount of water flowing out from the shower head 13 and the shower nozzle 15.

Moreover, the hole 432 of the socket 43 of the movable body 4 is for the shower nozzle 15 to be inserted in, and the socket 43 is pivotally disposed on the movable body 4. Thus, the socket 43 can rotate to adjust the angle for a user to take or hang the shower nozzle 15. The upper blocking part 401 and the lower blocking part 402 of the movable body 4 are respectively for the shower nozzle 15 to lean against, such that the rotating angle of the shower nozzle 15 is limited and the shower nozzle 15 is prevented from dropping when the rotating angle of the socket 43 is too much.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A diverter assembly for use in holding a shower head and a shower nozzle, comprising:
a main body, being hollow and having a water inlet tube and two water outlet tubes, one of the water outlet tube communicating with the shower nozzle through a hose;
a valve device, being assembled to the main body and having a valve capable of linearly moving back and forth to steplessly adjust fluid communication among the water inlet tube and the water outlet tubes; and
a movable body, engaging at one end of the main body and having a socket pivotally disposed therein, the socket having a hole for the shower nozzle to be inserted in.

2. The diverter assembly for use in holding a shower head and a shower nozzle according to claim 1, wherein the valve device has a partition communicating a first passage and a second passage, the first passage and the second passage communicating with one water outlet tube respectively, the valve being disposed in the partition and capable of moving steplessly between the first passage and the second passage to close the first passage and the second passage respectively or keep the first passage and the second passage open simultaneously.

3. The diverter assembly for use in holding a shower head and a shower nozzle according to claim 2, wherein the valve device has a first sleeve and a second sleeve sleeving with each other, the partition being formed between the first sleeve and the second sleeve.

4. The diverter assembly for use in holding a shower head and a shower nozzle according to claim 2, wherein a spiral sleeve is slidably disposed at the valve device and combined with an axis, the axis extending and passing through the partition, the valve is formed on the axis, one end on the spiral sleeve opposing the axis being spirally engaged with a spiral rod, the spiral rod being pivotally disposed to the main body by a cover, the spiral rod extending out of the cover and being combined with a knob, the knob being capable of rotating the spiral rod to slide the spiral sleeve and the axis.

5. The diverter assembly for use in holding a shower head and a shower nozzle according to claim 3, wherein three O-rings are disposed separately at outer edge of the first sleeve to form a first partition, a second partition and a third partition in the main body, the first partition communicating with the water inlet tube, the second partition and the third partition communicating with one water outlet tube respectively, the first sleeve having a first through hole communicating the first passage and the second partition for the first passage to be communicated with one water outlet tube, the second sleeve having a fourth partition communicating with the second passage and the third partition respectively for the second passage to be communicated with the other water outlet tube.

6. The diverter assembly for use in holding a shower head and a shower nozzle according to claim 4, wherein the valve device has an accommodating space, at least one sliding groove being disposed respectively at two opposite ends in a radial direction of the accommodating space, a slider being disposed respectively on the spiral sleeve opposing the two sliding grooves, the spiral sleeve being capable of linearly moving by cooperating of the two sliding grooves and the two sliders.

7. The diverter assembly for use in holding a shower head and a shower nozzle according to claim 1, wherein a sliding track is disposed at one end of the main body, a sliding groove being disposed on the movable body corresponding to the sliding track for the movable body to be engaged to the main body by cooperating of the sliding groove and the sliding track.

8. The diverter assembly for use in holding a shower head and a shower nozzle according to claim 1, wherein the movable body is U-shaped and has an accommodating space, the socket is tightly engaged and pivotally disposed in the accommodating space, an upper blocking part and a lower blocking part being formed at an upper edge and a lower edge of the movable body connecting the accommodating space respectively for the shower nozzle to lean against and limit a rotating angle of the shower nozzle.

9. The diverter assembly for use in holding a shower head and a shower nozzle according to claim 8, wherein a protruding axis is disposed at two ends of the socket, an axial hole being disposed on the movable body corresponding to each of the protruding axis, the protruding axis being tightly engaged to the axial hole.

10. The diverter assembly for use in holding a shower head and a shower nozzle according to claim 8, wherein the hole of the socket has an opening for the shower nozzle to be inserted in.
